(19) United States
(12) Patent Application Publication
(10) Pub. No.: US 2025/0357819 A1
(43) Pub. Date: Nov. 20, 2025

(54) HIGH-EFFICIENCY AND HIGH-SPEED VACUUM CLEANER MOTOR

(71) Applicant: DONGGUAN CHI DRIVE MOTORS CO.,LTD, Dongguan (CN)

(72) Inventors: Tianyou Cao, Yiyang (CN); Zhenjian Zhang, Jiangmen (CN)

(21) Appl. No.: 19/287,659

(22) Filed: Jul. 31, 2025

(30) Foreign Application Priority Data
Apr. 25, 2025 (CN) 202520806993.5

(51) Int. Cl. H02K 5/173; A47L 5/22; A47L 9/28; F04D 25/06; F04D 29/40; H02K 5/20; H02K 7/08; H02K 11/33

(52) U.S. Cl. CPC H02K 5/1732; A47L 5/22; A47L 9/2889; F04D 25/06; F04D 29/403; H02K 5/207; H02K 7/083; H02K 11/33; H02K 2211/03

(57) ABSTRACT

A high-efficiency and high-speed vacuum cleaner motor includes a fan housing, a motor housing and an impeller housing. A stator is fixedly arranged in the motor housing. A rotor extends through the middle of the stator. A protection cover is fixedly mounted at an end, opposite to the impeller housing, of the motor housing. The protection cover and the impeller housing are respectively provided with a first bearing mounting cavity and a second bearing mounting cavity. Air is prevented from passing through bearings, and the protection cover, the impeller housing and an impeller cover the bearing mounting cavities to prevent the bearings against direct contact with an air duct; moreover, the stator is not directly exposed to the air duct, such that a stator core and the bearings are effectively protected, thus prolonging the service life of the motor.

### BACKGROUND OF THE INVENTION

### Technical Field

The disclosure relates to the technical field of vacuum cleaner motors, in particular to a high-efficiency and high-speed vacuum cleaner motor.

### Description of Related Art

It is commonly known that that a vacuum cleaner motor is the heart a vacuum cleaner, and the quality of the vacuum cleaner motor has a direct influence on the using effect of the vacuum cleaner. At present, in the design of an existing vacuum cleaner motor, a stator is arranged in an air duct and cooled mainly by means of an air flow. Because a coil on the stator will generate heat when the stator operates and the service life of the motor will be affected by continuous accumulation of heat, heat generated by the stator needs to be discharged by means of air produced by the motor. The stator of the existing vacuum cleaner motor is exposed to the air duct, and a rotor is located in the middle of the stator, so bearings of the rotor of the existing vacuum cleaner motor are also exposed to the air duct. Due to the presence of water or some large dust particles in the mopping environment of the vacuum cleaner, the bearings or a stator core will be easily damaged due to long-term contact with the water or large dust particles, thus compromising the service life of the motor.

### BRIEF SUMMARY OF THE INVENTION

In view of the defects in the prior art, the objective of the disclosure is to provide a high-efficiency and high-speed vacuum cleaner motor.

To fulfill the above objective, the disclosure adopts the following technical solution:

A high-efficiency and high-speed vacuum cleaner motor includes a fan housing, a motor housing and an impeller housing. The impeller housing is fixedly mounted at one end of the motor housing, and an air guide cavity is defined by the impeller housing and said end of the motor housing. The fan housing is disposed around the motor housing. A guide channel is formed between the fan housing and the motor housing and communicates with the air guide cavity. A stator is fixedly arranged in the motor housing. A rotor extends through a middle of the stator. A protection cover is fixedly mounted at the other end, opposite to the impeller housing, of the motor housing. The protection cover and the impeller housing are respectively provided with a first bearing mounting cavity and a second bearing mounting cavity. The first bearing mounting cavity and the second bearing mounting cavity are configured as semi-closed structures. One end of the rotor is mounted in the first bearing mounting cavity by means of a bearing, and the other end of the rotor is mounted in the second bearing mounting cavity by means of a bearing. An impeller is fixed to the rotor and located in the air guide cavity. The impeller is conical, and an impeller surface is arranged on a side surface of the impeller. A socket is arranged on an end surface, where the second bearing mounting cavity is formed, of the impeller housing. A tail end of the impeller is arranged in the socket and covers the second bearing mounting cavity.

Preferably, an outer end surface of the impeller is funnel-shaped, and the socket inclines gradually towards a periphery with an opening of the second bearing mounting cavity as a center, to fit the outer end surface of the impeller.

Preferably, the impeller is configured as a worm-gear type impeller structure.

Preferably, a prime number of blades are arranged on the impeller.

Preferably, a hole is formed in the end, close to the air guide cavity, of the motor housing, the hole communicates with an interior of the motor housing, an air passage is formed between the end, close to the protection cover, of the motor housing and an inner wall of the protection cover, and the air passage communicates with the guide channel.

Preferably, at least one pre-compressed pre-tightening spring is arranged in the first bearing mounting cavity or the second bearing mounting cavity, and the pre-tightening spring abuts against the corresponding bearing on the rotor.

Preferably, a circuit board electrically connected to the stator is arranged on the fan housing and located in the guide channel.

Preferably, the impeller housing is formed with a connecting port, the connecting port communicates with the air guide cavity, at least two blade rings are arranged in the connecting port, and guide blades are arranged on each of the blade rings in a ring array, wherein an inclination angle of the guide blades on the blade ring close to an inner side is less than an inclination angle of the guide blades on the blade ring close to an outer side.

Preferably, circular grooves are formed in a joint between the fan housing and the motor housing, a joint between the motor housing and one blade ring, and a joint between the blade rings.

By adopting the above technical solution of the disclosure, each bearing of the rotor is independently arranged in one semi-closed bearing mounting cavity, such that air will not pass through the bearings; the protection cover, the impeller shell and the impeller cover the bearing mounting cavities, such that the bearings are prevented against direct contact with an air duct; moreover, the stator is not directly exposed to the air duct, such that a stator core and the bearings are effectively protected in the specific operating environment of a vacuum cleaner, thus prolonging the service life of the motor.

### BRIEF DESCRIPTION OF THE SEVERAL VIEWS OF THE DRAWINGS

FIG. 1 is a schematic structural diagram according to one embodiment of the disclosure.

FIG. 2 is a sectional view according to one embodiment of the disclosure.

FIG. 3 is an exploded view according to one embodiment of the disclosure.

### DETAILED DESCRIPTION OF THE INVENTION

To better clarify the objectives, technical solutions and advantages of the disclosure, the disclosure is described in further detail below in conjunction with accompanying drawings and embodiments. It should be understood that the specific embodiments described here are merely used for explaining the disclosure rather than limiting the disclosure.

In the description of the disclosure, it should be understood that terms such as “center”, “longitudinal”, “horizontal”, “length”, “width”, “thickness”, “upper”, “lower”, “front”, “back”, “left”, “right”, “vertical”. “horizontal”, “top”, “bottom”, “inner”, “outer”, “clockwise” and “anticlockwise” are used to indicate directional or positional relations based on the accompanying drawings merely for the purpose of facilitating and simplifying the description of the disclosure, do not indicate or imply that devices or elements referred to must be in a specific direction or be configured and operated in a specific direction, and thus should not be construed as limitations of the disclosure. In addition, terms “first” and “second” are merely for the purpose of description and should not be construed as indicating or implying relative importance or implicitly indicating the number of technical features referred to. Therefore, a feature defined by “first” or “second” may explicitly or implicitly indicate the inclusion of one or more said feature. In the description of the disclosure, “multiple” refers to two or more, unless otherwise expressly and specifically defined.

In the description of the disclosure, it should be noted that unless otherwise expressly stated and defined, terms “mount”, “link” and “connect” should be understood in a broad sense. For example, “connect” may refer to fixed connection, detachable connection or integrated connection; mechanical connection or electrical connection; direct connection, indirect connection by means of an intermediate medium, or internal connection or interaction between two elements. Those ordinarily skilled in the art may appreciate the specific meanings of these terms in the disclosure according to specific circumstances.

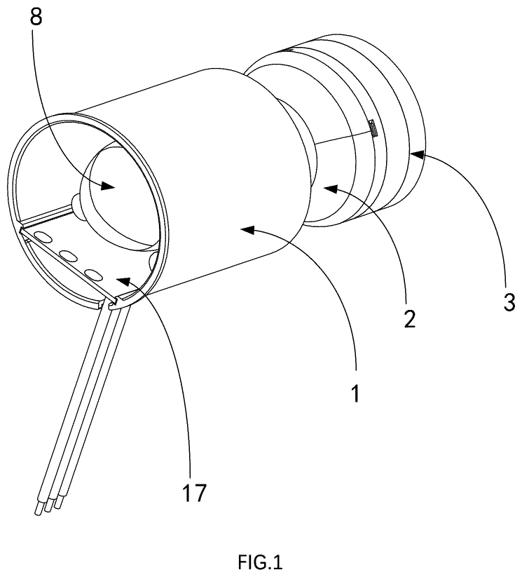

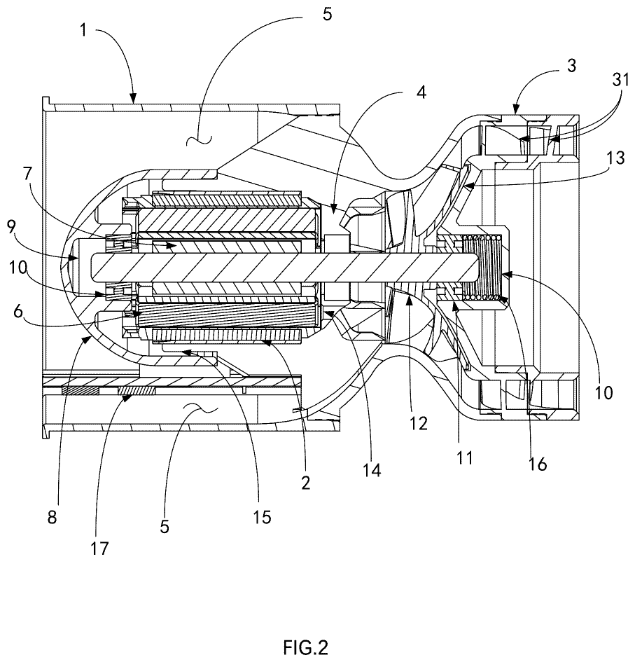

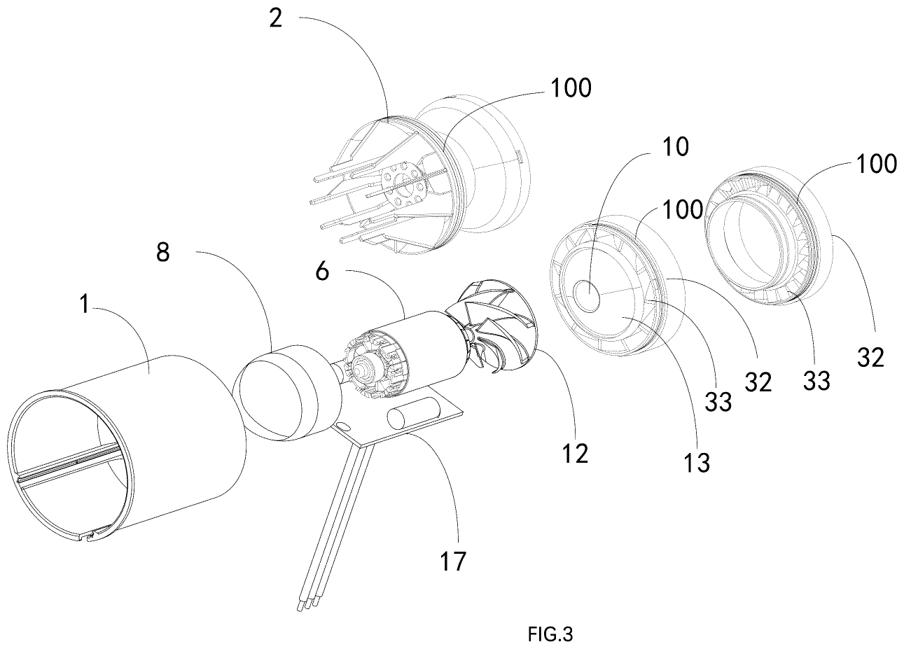

As shown in FIGS. 1-3, this embodiment provides a high-efficiency and high-speed vacuum cleaner motor, including a fan housing 1, a motor housing 2 and an impeller housing 3. The impeller housing 3 is fixedly mounted at one end of the motor housing 2, and an air guide cavity 4 is defined by the impeller housing 3 and said end of the motor housing 2. The fan housing 1 is disposed around the motor housing 2. A guide channel 5 is formed between the fan housing 1 and the motor housing 2 and communicates with the air guide cavity 4. A stator 6 is fixedly arranged in the motor housing 2. A rotor 7 penetrates through the middle of the stator 6. A protection cover 8 is fixedly mounted at the other end, opposite to the impeller housing 3, of the motor housing 2. The protection cover 8 and the impeller housing 3 are respectively provided with a first bearing mounting cavity 9 and a second bearing mounting cavity 10. The first bearing mounting cavity 9 and the second bearing mounting cavity 10 are configured as semi-closed structures (one end is of the semi-closed structure is open and the other end of the semi-closed structure is sealed, such that an air flow will not pass through bearings 11). One end of the rotor 7 is mounted in the first bearing mounting cavity 9 by means of one bearing 11, and the other end of the rotor 7 is mounted in the second bearing mounting cavity 10 by means of the other bearing 11. An impeller 12 is fixed to the rotor 7 and located in the air guide cavity 4. The impeller 12 is conical, and an impeller surface is arranged on a side surface of the impeller 12. A socket 13 is arranged on an end surface, where the second bearing mounting cavity 10 is formed, of the impeller housing 3. A tail end of the impeller 12 is arranged in the socket 13 and covers the second bearing mounting cavity 10.

In this embodiment, each bearing 11 of the rotor 7 is independently arranged in one semi-closed bearing mounting cavity, such that air will not flow through the bearings; the protection cover 8, the impeller housing 3 and the impeller 12 cover the bearing mounting cavities, such that the bearings 11 are prevented against direct contact with an air duct; and the stator 6 is prevented from being directly exposed to the air duct, such that a stator core and the bearings 11 are effectively protected in the specific operating environment of a vacuum cleaner, thus prolonging the service life of the motor.

When the high-efficiency and high-speed vacuum cleaner motor operates, the stator 6 is powered on, and a coil in the stator is powered on to generate a corresponding magnetic field to drive the rotor 7 to rotate; when the rotor 7 rotates, the impeller 12 rotates synchronously; when the impeller 12 rotates, air is generated in the air guide cavity 4, wherein the flowing direction of the air will vary according to different rotation directions of the impeller 12; and whether air flows into the impeller housing 3 or flows out of the impeller housing 3 is set. When the air pressure in the air guide cavity 4 changes, air passes through the space between the guide channel 5 and the impeller housing 3 to be used by a vacuum cleaner. Wherein, air is guided mainly in an air duct formed by the guide channel 5, the air guide cavity 4 and the impeller housing 3, the bearings 11 and the stator 6 are not directly exposed to the air duct, such that the bearings 11 and the stator 6 are protected.

Further, to better cover the bearing 11 at the position of the impeller 12, in this embodiment, an outer end surface of the impeller 12 is funnel-shaped, and the socket 13 inclines gradually towards the periphery with an opening of the second bearing mounting cavity 10 as a center, to fit the outer end surface of the impeller 12, and the impeller 12 may function as a surface cover to cover the bearing 11. Although a gap exists between the socket 13 and the impeller 12, the whole second bearing mounting cavity 10 is a semi-closed structure with the front side not communicating with the back side, such that air flowing through the air duct is unlikely to enter the second bearing mounting cavity 10.

Further, as for the impeller 12, in this embodiment, the impeller 12 is configured as a worm-gear type impeller structure, and a prime number of blades are arranged on the impeller 12. By adopting a prime number of blades, resonance may be reduced.

Further, to allow part of air to directly cool the interior of the motor housing 2, in this embodiment, a hole 14 is formed in the end, close to in the air guide cavity 4, of the motor housing 2, the hole 14 communicates with the interior of the motor housing 2, an air passage 15 is formed between the end, close to the protection cover 8, of the motor housing 2 and an inner wall of the protection cover 8, and the air passage 15 is connected to the guide channel 5. In this way, when the vacuum cleaner motor operates, the hole 14, the interior of the motor housing 2, the air passage 15 and the guide channel 5 will communicate with each other to take away heat in the motor housing 2. By adopting such an arrangement, although the stator 6 is still in contact with air to some extent, the stator 6 is not directly exposed to the air duct, thus being protected to a great extent.

Further, to improve the stability of the rotor 7 in operation, in this embodiment, at least one pre-compressed pre-tightening spring 16 is arranged in the first bearing mounting cavity 9 or the second bearing mounting cavity 10, and the pre-tightening spring 16 abuts against the corresponding bearing 11 on the rotor 7, such that a pre-tightening force is applied to the rotor 7 to keep the rotor 7 more stable during high-speed rotation.

Further, to better cool a circuit board 17, in this embodiment, the circuit board 17 electrically connected to the stator 6 is arranged on the fan housing 1 and located in the guide channel 5, that is, the circuit board 17 is arranged in the guide channel 5, such that when air passes through the guide channel 5, the circuit board will be cooled. Meanwhile, to improve the cooling efficiency of power elements of the circuit board 17 and the protection level of the circuit board 17, the fan housing 1 may be made from heat-conducting metal or other materials with good heat conductivity. When the circuit board 17 is placed in the guide channel 5, heating power elements on the circuit board 17 are pasted on the fan housing 1 by means of heat-conducting silicone stickers, and multiple cooling fins are arranged on an inner wall of the fan housing 1 to further improve the cooling efficiency.

Further, as for the impeller housing 3, in this embodiment, the impeller housing 3 is formed with a connecting port 31, the connecting port 31 communicates with the air guide cavity 4, at least two blade rings 32 are arranged in the connecting port 31, and guide blades 33 are arranged on each of the blade rings 32 in a ring array, wherein an inclination angle of the guide blades 33 on the blade ring 32 close to the inner side is less than an inclination angle of the guide blades 33 on the blade ring 32 close to the outer side, such that less guide blades 33 may be arranged on the blade ring 32 on the inner side, the distance between the guide blades 33 is greater, and more guide blades 33 may be arranged on the other blade ring 32 more densely; and guide gaps are formed between the guide blades. By adopting such an arrangement, the guide gaps in different blade rings 32 are in different directions, and the amount of air directly passing through the impeller housing 3 is reduced, and the pressure of the generated air flow is increased twice by means of the two blade rings 32. The specific number of the blade rings 32 is not limited in this embodiment.

Further, to more firmly bond together the fan housing 1 and the motor housing 2, the motor housing 2 and the impeller housing 3, and the blade rings 32 with glue during actual assembly, in this embodiment, circular grooves 100 are formed in a joint between the fan housing 1 and the motor housing 2, a joint between the motor housing 2 and one blade ring 32, and a joint between the blade rings 32. When the fan housing 1 and the motor housing 2, the motor housing 2 and the impeller housing 3, and the blade rings 32 are bonded, glue is directly smeared in the circular grooves 100 and may be retained in the circular grooves 100, such that the bonding strength of the glue is improved.

The above embodiments are merely preferred ones of the disclosure and are not intended to limit the patent scope of the disclosure. All equivalent structures or flow transformations made according to the contents in the description and accompanying drawings of the disclosure, or direct or indirect applications to other related technical fields should also fall within the patent protection scope of the disclosure.

What is claimed is:

1. A high-efficiency and high-speed vacuum cleaner motor, comprising a fan housing, a motor housing and an impeller housing, wherein the impeller housing is fixedly mounted at one end of the motor housing, an air guide cavity is defined by the impeller housing and said end of the motor housing, the fan housing is disposed around the motor housing, a guide channel is formed between the fan housing and the motor housing and communicates with the air guide cavity, a stator is fixedly arranged in the motor housing, a rotor extends through a middle of the stator, a protection cover is fixedly mounted at the other end, opposite to the impeller housing, of the motor housing, the protection cover and the impeller housing are respectively provided with a first bearing mounting cavity and a second bearing mounting cavity, the first bearing mounting cavity and the second bearing mounting cavity are configured as semi-closed structures, one end of the rotor is mounted in the first bearing mounting cavity by means of a bearing, the other end of the rotor is mounted in the second bearing mounting cavity by means of a bearing, an impeller is fixed to the rotor and located in the air guide cavity, the impeller is conical, an impeller surface is arranged on a side surface of the impeller, a socket is arranged on an end surface, where the second bearing mounting cavity is formed, of the impeller housing, a tail end of the impeller is arranged in the socket and covers the second bearing mounting cavity.

2. The high-efficiency and high-speed vacuum cleaner motor according to claim 1, wherein an outer end surface of the impeller is funnel-shaped, and the socket inclines gradually towards a periphery with an opening of the second bearing mounting cavity as a center, to fit the outer end surface of the impeller.

3. The high-efficiency and high-speed vacuum cleaner motor according to claim 2, wherein the impeller is configured as a worm-gear type impeller structure.

4. The high-efficiency and high-speed vacuum cleaner motor according to claim 3, wherein a prime number of blades are arranged on the impeller.

5. The high-efficiency and high-speed vacuum cleaner motor according to claim 1, wherein a hole is formed in the end, close to the air guide cavity, of the motor housing, the hole communicates with an interior of the motor housing, an air passage is formed between the end, close to the protection cover, of the motor housing and an inner wall of the protection cover, and the air passage communicates with the guide channel.

6. The high-efficiency and high-speed vacuum cleaner motor according to claim 1, wherein at least one pre-compressed pre-tightening spring is arranged in the first bearing mounting cavity or the second bearing mounting cavity, and the pre-tightening spring abuts against the corresponding bearing on the rotor.

7. The high-efficiency and high-speed vacuum cleaner motor according to claim 1, wherein a circuit board electrically connected to the stator is arranged on the fan housing and located in the guide channel.

8. The high-efficiency and high-speed vacuum cleaner motor according to claim 1, wherein the impeller housing is formed with a connecting port, the connecting port communicates with the air guide cavity, at least two blade rings are arranged in the connecting port, and guide blades are arranged on each of the blade rings in a ring array, wherein an inclination angle of the guide blades on the blade ring close to an inner side is less than an inclination angle of the guide blades on the blade ring close to an outer side.

9. The high-efficiency and high-speed vacuum cleaner motor according to claim 8, wherein circular grooves are formed in a joint between the fan housing and the motor housing, a joint between the motor housing and one said blade ring, and a joint between the blade rings.
